(19) United States
(12) Patent Application Publication
(10) Pub. No.: US 2026/0149933 A1
(43) Pub. Date: May 28, 2026

(54) VISUAL INDICATION OF RECEIVER STATUS FOR A HEARING DEVICE

(71) Applicant: Starkey Laboratories, Inc., Eden Prairie, MN (US)

(72) Inventors: Ramsey Albert Statz, Minneapolis, MN (US); Margaret Introwitz-Williams, Minneapolis, MN (US); Jonathan Doty, Bloomington, MN (US); Jeff Patrick Kryzer, Maple Grove, MN (US); David Alan Fabry, Eden Prairie, MN (US); Sidney A. Higgins, Maple Grove, MN (US)

(21) Appl. No.: 19/392,666

(22) Filed: Nov. 18, 2025

Related U.S. Application Data
(60) Provisional application No. 63/723,824, filed on Nov. 22, 2024.

(51) Int. Cl. H04R 25/00; G08B 7/06; H04R 29/00

(52) U.S. Cl. CPC H04R 25/30; G08B 7/06; H04R 25/50; H04R 25/554; H04R 29/008; H04R 2225/021; H04R 2225/025

(57) ABSTRACT

Disclosed herein, among other things, are systems and methods for providing a visual indication of receiver status for hearing devices. Various aspects include a system for providing a visual indication of compatibility for an in-field receiver cable change for a hearing device. The system includes one or more display elements on or in a housing of a hearing device. The system also includes at least one processor configured to detect a connection of a receiver cable to the hearing device, determine whether the receiver cable is compatible with a current programming of the hearing device, and based on whether the receiver cable is compatible with the current programming, use the one or more display elements to provide a notification to a user of the hearing device.

### CLAIM OF PRIORITY AND INCORPORATION BY REFERENCE

The present application claims the benefit under 35 U.S.C. § 119(e) of U.S. Provisional Patent Application 63/723,824, filed Nov. 22, 2024, the disclosure of which is hereby incorporated by reference herein in its entirety.

### TECHNICAL FIELD

This document relates generally to hearing device systems and more particularly to systems and methods for providing a visual indication of receiver status for a hearing device.

### BACKGROUND

Audio devices can be used to provide audible output to a user based on received wireless signals. Examples of audio devices include speakers and ear-wearable devices, also referred to herein as hearing devices. Example of hearing devices include hearing assistance devices or hearing instruments, including both prescriptive devices and non-prescriptive devices. Specific examples of hearing devices include, but are not limited to, hearing aids, headphones, and earbuds.

Hearing aids are used to assist patients suffering hearing loss by transmitting amplified sounds to ear canals. In one example, a hearing aid is worn in and/or around a patient's ear. Hearing aids may include processors and electronics that improve the listening experience for a specific wearer or in a specific acoustic environment.

Some hearing aids, such as receiver-in-the-canal (RIC) hearing aids, may include replaceable receivers (or speakers) that attach to the hearing aid housing using a cable. However, not all receivers may be compatible with each hearing aid, such that a change in receiver by a wearer may result in an incompatible receiver being connected to the hearing aid. In addition, some receivers may have different maximum capabilities that may not mesh with the requirements of a wearer of a hearing aid.

Thus, there is a need in the art for improved systems and methods for providing a visual indication of receiver status for ear-wearable devices.

### SUMMARY

Disclosed herein, among other things, are systems and methods for providing a visual indication of receiver status for hearing devices. Various aspects include a system for providing a visual indication of compatibility for an in-field receiver cable change for a hearing device. The system includes one or more display elements on or in a housing of a hearing device. The system also includes at least one processor configured to detect a connection of a receiver cable to the hearing device, determine whether the receiver cable is compatible with a current programming of the hearing device, and based on whether the receiver cable is compatible with the current programming, use the one or more display elements to provide a notification to a user of the hearing device.

Various aspects include a system for providing a visual indication of receiver status for a hearing device. The system includes one or more display elements on or in a housing of a hearing device. The system also includes at least one processor configured to determine whether a receiver connected to the hearing device is streaming audio from the hearing device, determine whether the hearing device has activated ambient microphones of the hearing device, and based on whether the receiver of the hearing device is streaming audio or the hearing device has activated ambient microphones, use the one or more display elements to provide a notification to a user of the hearing device.

Various aspects include a system for providing a visual indication of receiver capabilities for a hearing device. The system includes one or more display elements on or in a housing of a hearing device. The system also includes at least one processor configured to determine a receiver size of a receiver connected to the hearing device, determine whether a receiver size of the receiver has sufficient headroom to provide an output audible by a wearer of the hearing device, and based on whether the receiver size of the receiver has sufficient headroom to provide the output audible, use the one or more display elements to provide a notification to a user of the hearing device.

This Summary is an overview of some of the teachings of the present application and not intended to be an exclusive or exhaustive treatment of the present subject matter. Further details about the present subject matter are found in the detailed description and appended claims.

### BRIEF DESCRIPTION OF THE DRAWINGS

Various embodiments are illustrated by way of example in the figures of the accompanying drawings. Such embodiments are demonstrative and not intended to be exhaustive or exclusive embodiments of the present subject matter.

FIG. 1 illustrates a perspective view of a hearing device system for providing a visual indication of receiver status, according to various examples of the present subject matter.

FIG. 2A illustrates a flow diagram of a method for providing a visual indication of compatibility for an in-field receiver cable change for a hearing device, according to various examples of the present subject matter.

FIG. 2B illustrates a flow diagram of a method for providing a visual indication of receiver status for a hearing device, according to various examples of the present subject matter.

FIG. 2C illustrates a flow diagram of a method for providing a visual indication of receiver capabilities for a hearing device, according to various examples of the present subject matter.

FIG. 3 illustrates a block diagram of a hearing device circuit, according to various examples of the present subject matter.

FIG. 4 illustrates a block diagram of an example machine upon which any one or more of the techniques discussed herein may perform.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment, including combinations of such embodiments. The following detailed description is demonstrative and not to be taken in a limiting sense. The scope of the present subject matter is defined by the appended claims, along with the full scope of legal equivalents to which such claims are entitled.

The present detailed description will discuss audio devices such as hearing devices and speakers. The description refers to hearing devices or hearing instruments generally, which include earbuds, headsets, headphones, and hearing assistance devices using the example of hearing aids. Other hearing devices include, but are not limited to, those in this document. It is understood that their use in the description is intended to demonstrate the present subject matter, but not in a limited or exclusive or exhaustive sense.

Some hearing aids, such as receiver-in-the-canal (RIC) hearing aids, may include replaceable receivers (or speakers) that attach to the hearing aid housing using a cable. However, not all receivers may be compatible with each hearing aid, such that a change in receiver by a wearer may result in an incompatible receiver being connected to the hearing aid. In addition, some receivers may have different maximum capabilities that may not mesh with the requirements of a wearer of a hearing aid.

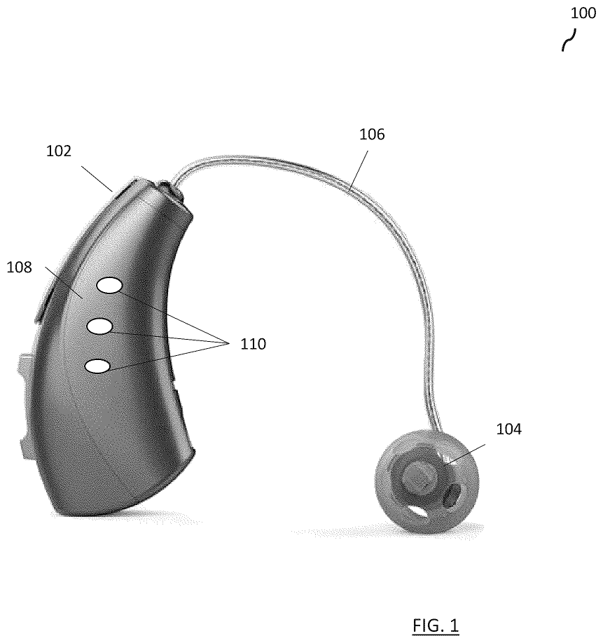

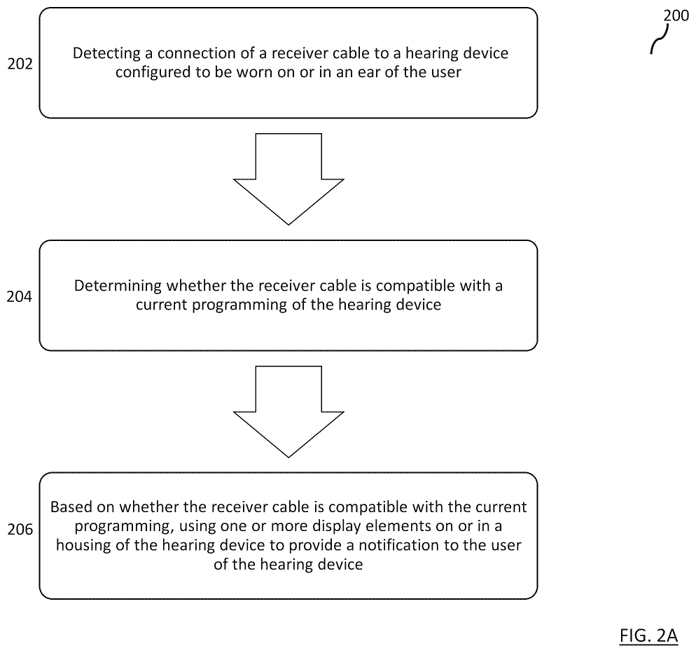

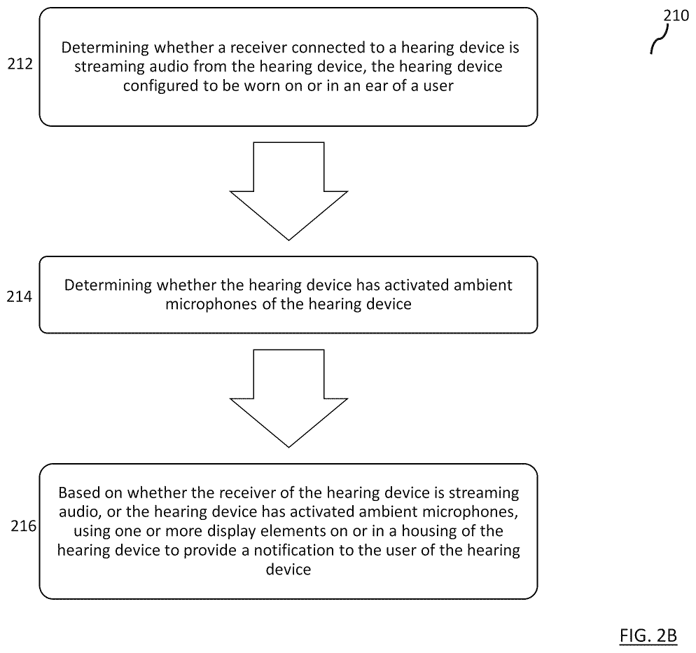

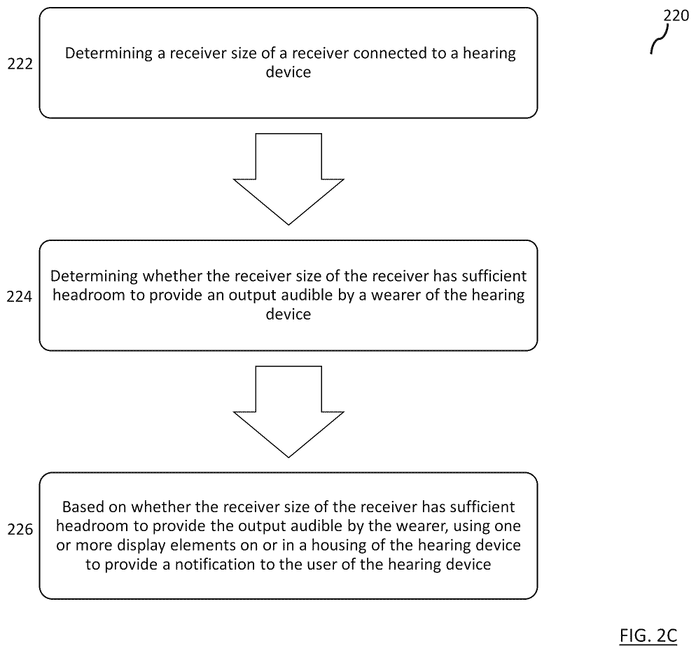

FIG. 1 illustrates a perspective view of a hearing device system for providing a visual indication of receiver status, according to various examples of the present subject matter. The system 100 includes one or more display elements 110 on or in a housing 108 of a hearing device 102. A receiver 104 is connected to the hearing device 102 using a cable 106. The system 100 further includes at least one processor configured to determine a status of the receiver 104 or receiver cable 106 connected to the hearing device 102, and based on the status of the receiver 104 or receiver cable 106, use the one or more display elements to provide a notification to a user of the hearing device. In various examples, the one or more display elements 110 include light emitting diodes (LEDs). Various examples of determining status of the receiver 104 or receiver cable 106 are described, but not limited to, the methods depicted in FIGS. 2A-2B.

FIG. 2A illustrates a flow diagram of a method for providing a visual indication of compatibility for an in-field receiver cable change for a hearing device, according to various examples of the present subject matter. The method 200 includes detecting a connection of a receiver cable to the hearing device, at operation 202. At operation 204, the method 200 includes determining whether the receiver cable is compatible with a current programming of the hearing device. Based on whether the receiver cable is compatible with the current programming, the one or more display elements are used to provide a notification to a user of the hearing device, at operation 206.

In various examples, the one or more display elements include LEDs. In other examples, the one or more display elements include a graphical display. The notification may include providing a programmable color, providing a programmable sequence, and/or providing a legible message using the one or more display elements, in various examples. In some examples, the notification includes providing an audible message delivered via a receiver of the hearing device. In still further examples, the notification may include a message sent to an electronic device in communication with the hearing device, such as a programmer for the hearing device, a smartwatch, or a smartphone. The message may be sent using a wireless network, in an example. In various examples, the notification includes an implied or express instruction for the user to reprogram the hearing device to be compatible with the receiver cable. As used herein, the term user may refer to a wearer of the hearing device, clinician or audiologist. In some examples, the at least one processor is further configured to process an audio signal to correct for a hearing impairment of a wearer of the hearing device.

FIG. 2B illustrates a flow diagram of a method for providing a visual indication of receiver status for a hearing device, according to various examples of the present subject matter. The method 210 includes determining whether a receiver connected to the hearing device is streaming audio from the hearing device, at operation 212. At operation 214, the method 210 includes determining whether the hearing device has activated ambient microphones of the hearing device. Based on whether the receiver of the hearing device is streaming audio or the hearing device has activated ambient microphones, the one or more display elements are used to provide a notification to a user of the hearing device, at operation 216. In various examples, the hearing device is a hearing aid, such as a behind-the-ear (BTE) hearing aid, a receiver-in-the-canal (RIC) hearing aid, or a receiver-in-the-ear (RITE) hearing aid.

FIG. 2C illustrates a flow diagram of a method for providing a visual indication of receiver capabilities for a hearing device, according to various examples of the present subject matter. The method 220 includes determining a receiver size of a receiver connected to the hearing device, at operation 222. At operation 224, the method 220 includes determining whether a receiver size of the receiver has sufficient headroom to provide an output audible by a wearer of the hearing device. Based on whether the receiver size of the receiver has sufficient headroom to provide the output audible, the one or more display elements are used to provide a notification to a user of the hearing device, at operation 226. The one or more display elements include LEDs, and the notification includes providing a programmable color and/or a programmable sequence using the one or more display elements, in various examples.

Some hearing devices may be compatible with more than one receiver or more than one receiver cable, which may be sourced from different manufacturers. However, these receivers and receiver cables may have different acoustic properties. This is not a problem if a change or receivers or receiver cables is done during a fitting software session, but it may be a problem if the change is done outside of the fitting software session. Currently, if a user attempts to swap a receiver or receiver cable outside of the fitting software session, the acoustics of the hearing device may be impacted.

The present subject matter provides a notification to the user, such as by using a display or display elements on a device housing, to alert the user that the receiver or receiver cable has different acoustic properties, so that the user can make the necessary fitting adjustments for proper device performance. In some examples, LEDs on a RIC hearing device may be used to provide the notification to the user when it is detected that a new receiver cable is plugged into the hearing device, and that the hearing device is not currently programmed for the new receiver cable. In this example, the hearing device then provides a visual indication to the user (in the form of an LED sequence, for example) to indicate that the hearing device should to be brought into the fitting software to be properly programmed. In another example, the hearing device may provide a different visual indication when the hearing device is already programmed for the new cable and no re-programming is needed. In some examples, multiple variants of a cable type (e.g., “M cable” or “P cable”, where the letter indicates power level of the receiver) may be used with a single device and the present system makes this transparent to the end user.

In various examples, in addition to receiver compatibility, the present system may be used to indicate a receiver status. For example, the system may determine whether the receiver is streaming audio from the device or whether the ambient microphones are active. Then the system may provide a notification to the user regarding the determined user status. This is a further benefit to hearing device users that struggle to understand the current receiver status and the implications of said status for device usage.

According to various examples, the present system may be used to indicate whether the use of the connected receiver is nearing max capabilities of the receiver. Because hearing device receivers come in different sizes, such as 40 gain, 60 gain, 70 gain, 80 gain, each device user may be prescribed a specific minimum gain receiver to provide the needed amplification for the user. In one example, for a patient with mild to moderate hearing loss, a 40 gain receiver might be used. The 40 gain receiver is smaller, which allows for a smaller custom hearing device, or a smaller or more comfortable in-ear portion of an RIC hearing device. In other examples, a patient with more significant hearing loss might need a 60 gain receiver to provide more amplification, and a patient with severe loss might need a 70 gain or 80 gain receiver. In various examples, the present system may determine whether the hearing aid output is approaching the upper limits of the receiver, i.e., it is running out of “headroom”. In one example, the system may provide a notification to the user using the one or more display elements based on this determination the receiver is approaching upper limits. For example, one indicia (e.g., color of the display elements) may indicate that ample headroom is available, a second indicia (e.g., number of illuminated display elements) may indicate that the headroom is below a specified amount (e.g., less than 5%), and a third indicia (e.g., sequence of flashing of the display elements) may indicate that the hearing aid has maxed out the headroom. The receiver may approach upper limits when a patient's hearing degrades over time, such that the user's hearing loss proceeds to the point that they need to upgrade their hearing devices to include a larger receiver. The notification mentioned above may be presented during start-up of the devices, or may periodically flash, or may occur during or after a self-check, or may occur during a remote fitting session or in-person fitting session, or may occur responsive to a command sent from an accessory (e.g., smartphone) or over a network (e.g., over the internet during a remote fitting), in various examples.

In various examples, the notification is provided via an LED on the RIC cable or on the hearing, but a notification may alternatively or additionally be via a smartphone application, smart watch application, audio notification, or through a network (e.g., over the internet or other network during a remote fitting session). In one example, if a user swaps an M receiver cable for a P receiver cable, a notification would indicate to the user that action is required to program the device for the newly-attached cable. Other types of notifications may include, but are not limited to, LED colors, LED sequences, notifications to a smartphone, notifications to a hearing professional through a remote fitting system, or an audio notification through the hearing device or smartphone. In one example, the LED notification is advantageous because the user will know right away that action required, and the user does not have to put the device or receiver in their ear to get the notification.

In some examples, a notification may be a combination of any of the above, e.g., an LED and a notification through a network to a hearing professional (such as an audiologist) during a remote fitting session, so that both the patient and the remote professional get the notification. In one example, only the hearing professional receives the notification. In further examples, the display elements may be used to provide notifications to indicate to the user that the hearing device is not in ear when feedback cancellation is being executed. In still further examples, the display elements may be used to provide notifications to indicate to the user that the hearing device is in test mode. For example, the display elements may provide a steady state flashing when the device is in test mode. To bring the device out of test mode, it may be connected to a fitting system, in some examples. In various examples, the display elements may be used to provide notifications to provide feedback on a field firmware update, such as to indicate whether the firmware update was successful. In another example, the display elements may be used to provide notifications to indicate to the user that there is a pending firmware update that can be installed. In a further example, the display elements may be used to provide notifications to indicate to the user that the hearing device has failed a self-check, such as a self-check initiated upon putting the device into a charger, or an automatic self-check. In yet another example, the display elements may be used to provide notifications to indicate to the user that the hearing device has passed or failed a visual inspection during manufacturing or operations, such as a visual inspection to confirm that the device is ready for use and no longer in test mode.

The present subject matter provides a number of benefits. For example, this system leverages display elements to provide notifications to users when the device is on or off of the ear. This is especially useful because swapping a receiver or receiver cable is necessarily be done while a patient is not wearing the hearing device, which means an audible indicator is not a feasible solution. In addition, this system enables multiple-sourcing of receiver parts, which provides a business competitive advantage for a hearing device manufacturer. Other solutions for multiple-sourcing of parts that have acoustic differences had used geographic segregation of parts, which will no longer be needed using this system

In various examples, the present subject matter may use hardware already existing on a hearing device. The present subject matter may be implemented in a hearing aid or an earbud or any ear-worn device, in various examples. Various types of hearing devices may be used with the present receiver status notification system, including but not limited to hearing aids.

According to various examples, the present system processes collected data using a processor in or on the hearing device. Other processors may be used, such as in remote devices (e.g., in a smartphone) that are in communication with the hearing device. The logged data may be stored locally on the hearing device or remotely, such as on cloud storage, or using an application on mobile device. In some examples, the present system uses machine learning, including but not limited to a deep neural network or artificial intelligence, to process the tracked data. The machine learning processor, either local or remote, may be trained on data from the user and/or data from multiple users or participants.

The present method provides notifications of hearing device receiver status, in various examples. In some examples, the present method provides notification to the user via the hearing device or in a smartphone application associated with the hearing device. The present method may also or alternatively provide notification to a healthcare provider of the user, such that the user's doctor or other individual (such as another health care provider, family member, or the like) may also keep track of patient data.

In some examples, the present method may be used in reverse, or by initiating or preparing to initiate processing when the user disconnects a receiver cable. The present methods may also be initiated or prepared to be initiated upon power up of the hearing device. However, the hearing device takes time to boot up and decrypt firmware, so if the device is coming out of the charger, there might be a boot up or delay time and recording of sensor data may not begin immediately.

In some examples, the sensor data is logged in a hearing device. The sensor data may be logged in external devices or in the cloud, in various examples. In various examples, the present method and system may be programmed into firmware of the device. In other examples, a separate program or device may be used to track and record the sensor data for the user.

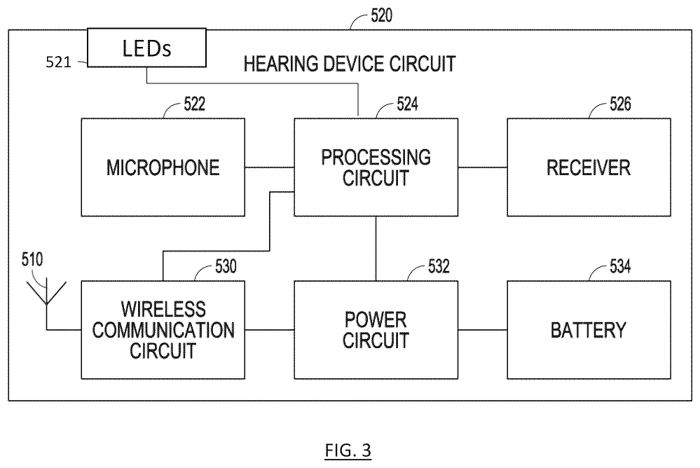

FIG. 3 illustrates a block diagram of a hearing device circuit, according to various examples of the present subject matter. Hearing device circuit 520 represents an example of portions of a hearing device and includes a microphone 522, a wireless communication circuit 530, an antenna 510, one or more display elements, such as LEDs 521, a processing circuit 524, a receiver (speaker) 526, a battery 534, and a power circuit 532. Microphone 522 receives sounds from the environment of the hearing device user (wearer of the hearing device). Wireless communication circuit 530 communicates with another device wirelessly using antenna 510, including receiving programming codes, streamed audio signals, and/or other audio signals and transmitting programming codes, audio signals, and/or other signals. Examples of the other device includes other hearing devices of other users, another hearing device of a pair of hearing devices for the same wearer, a hearing device host device, an assistive listening device (ALD), an audio streaming device, a smartphone, and other devices capable of communicating with hearing devices wirelessly. Processing circuit 524 controls the operation of a hearing device using the programming codes and processes the sounds received by microphone 522 and/or the audio signals received by wireless communication circuit 530 to produce output sounds. Receiver 526 transmits output sounds to an ear canal of the hearing device wearer. Battery 534 and power circuit 532 constitute the power source for the operation of hearing device circuit 520. In one example, power circuit 532 can include a power management circuit. In another alternative or additional example, battery 534 can include a rechargeable battery and power circuit 532 can include a recharging circuit for recharging the rechargeable battery.

In various examples, the hearing device is configured providing notifications to users based on receiver status using LEDs 521. The hearing device circuit 520 includes at least one processor or processing circuit 524 and data storage in communication with the processing circuit 524. The data storage comprises instructions thereon that, when executed by the processing circuit 524, causes the processing circuit 524 to perform the functions of the present systems and methods, such as the methods depicted in FIGS. 2A-2C. For example, the processing circuit may perform operations to: detect a connection of a receiver cable to the hearing device, determine whether the receiver cable is compatible with a current programming of the hearing device, and based on whether the receiver cable is compatible with the current programming, use the one or more display elements to provide a notification to a user of the hearing device. While the LEDs 521 are depicted within the hearing device, the LEDs 521 may be outside the device, incorporated into a housing of the device, or in any other position inside or outside the device. The hearing device circuit 520 may be included in an ear bud, headphones, a hearing aid, or other ear-wearable device, in various examples.

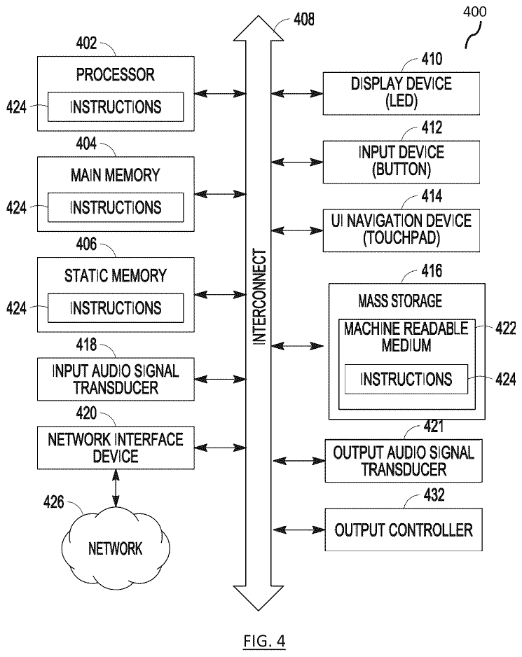

FIG. 4 illustrates a block diagram of an example machine 400 upon which any one or more of the techniques (e.g., methodologies) discussed herein may perform. In alternative examples, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a hearing device, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 400 may include a hardware processor 402 (e.g., a central processing unit (CPU), a graphics processing unit (GPU), a hardware processor core, or any combination thereof), a main memory 404, and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example, the display unit 410, input device 412, and UI navigation device 414 may be a touch screen display. The machine 400 may additionally include a storage device (e.g., drive unit) 416, one or more input audio signal transducers 418 (e.g., microphone), a network interface device 420, and one or more output audio signal transducers 421 (e.g., speaker). The machine 400 may include an output controller 432, such as a serial (e.g., universal serial bus (USB), parallel, or other wired or wireless (e.g., infrared (IR), near-field communication, etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine-readable medium examples may include solid-state memories, and optical and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include: non-volatile memory, such as semiconductor memory devices (e.g., Electrically Programmable Read-Only Memory (EPROM), Electrically Erasable Programmable Read-Only Memory (EEPROM) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to communicate wirelessly using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 400, and includes digital or analog communications signals or other intangible medium to facilitate communication of such software.

Various examples of the present subject matter support wireless communications with a hearing device. In various examples the wireless communications may include standard or nonstandard communications. Some examples of standard wireless communications include link protocols including, but not limited to, Bluetooth™, BLE, Auracast, IEEE 802.11(wireless LANs), 802.15 (WPANs), 802.16 (WiMAX), cellular protocols including, but not limited to CDMA and GSM, ZigBee, and ultra-wideband (UWB) technologies. Such protocols support radio frequency communications and some support infrared communications while others support NFMI. Although the present system is demonstrated as a radio system, it is possible that other forms of wireless communications may be used such as ultrasonic, optical, infrared, and others. It is understood that the standards which may be used include past and present standards. It is also contemplated that future versions of these standards and new future standards may be employed without departing from the scope of the present subject matter.

The wireless communications support a connection from other devices. Such connections include, but are not limited to, one or more mono or stereo connections or digital connections having link protocols including, but not limited to 802.3 (Ethernet), 802.4, 802.5, USB, SPI, PCM, ATM, Fibre-channel, Firewire or 1394, InfiniBand, or a native streaming interface. In various examples, such connections include all past and present link protocols. It is also contemplated that future versions of these protocols and new future standards may be employed without departing from the scope of the present subject matter.

Hearing assistance devices typically include at least one enclosure or housing, a microphone, hearing assistance device electronics including processing electronics, and a speaker or “receiver.” Hearing assistance devices may include a power source, such as a battery. In various examples, the battery is rechargeable. In various examples multiple energy sources are employed. It is understood that in various examples the microphone is optional. It is understood that in various examples the receiver is optional. It is understood that variations in communications protocols, antenna configurations, and combinations of components may be employed without departing from the scope of the present subject matter. Antenna configurations may vary and may be included within an enclosure for the electronics or be external to an enclosure for the electronics. Thus, the examples set forth herein are intended to be demonstrative and not a limiting or exhaustive depiction of variations.

It is understood that digital hearing assistance devices include a processor. In digital hearing assistance devices with a processor, programmable gains may be employed to adjust the hearing assistance device output to a wearer's particular hearing impairment. The processor may be a digital signal processor (DSP), microprocessor, microcontroller, other digital logic, or combinations thereof. The processing may be done by a single processor, or may be distributed over different devices. The processing of signals referenced in this application may be performed using the processor or over different devices. Processing may be done in the digital domain, the analog domain, or combinations thereof. Processing may be done using subband processing techniques. Processing may be done using frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, buffering, and certain types of filtering and processing. In various examples of the present subject matter the processor is adapted to perform instructions stored in one or more memories, which may or may not be explicitly shown. Various types of memory may be used, including volatile and nonvolatile forms of memory. In various examples, the processor or other processing devices execute instructions to perform a number of signal processing tasks. Such examples may include analog components in communication with the processor to perform signal processing tasks, such as sound reception by a microphone, or playing of sound using a receiver (i.e., in applications where such transducers are used). In various examples of the present subject matter, different realizations of the block diagrams, circuits, and processes set forth herein may be created by one of skill in the art without departing from the scope of the present subject matter.

It is further understood that different hearing devices may embody the present subject matter without departing from the scope of the present disclosure. The devices depicted in the figures are intended to demonstrate the subject matter, but not necessarily in a limited, exhaustive, or exclusive sense. It is also understood that the present subject matter may be used with a device designed for use in the right ear or the left ear or both ears of the wearer.

The present subject matter is demonstrated for hearing devices, including hearing assistance devices, including but not limited to, behind-the-ear (BTE), in-the-ear (ITE), in-the-canal (ITC), receiver-in-canal (RIC), invisible-in-canal (IIC) or completely-in-the-canal (CIC) type hearing assistance devices. It is understood that behind-the-ear type hearing assistance devices may include devices that reside substantially behind the ear or over the ear. Such devices may include hearing assistance devices with receivers associated with the electronics portion of the behind-the-ear device, or hearing assistance devices of the type having receivers in the ear canal of the user, including but not limited to RIC or receiver-in-the-ear (RITE) designs. The present subject matter may also be used in hearing assistance devices generally, such as cochlear implant type hearing devices. The present subject matter may also be used in deep insertion devices having a transducer, such as a receiver or microphone. The present subject matter may be used in bone conduction or otherwise osseointegrated hearing devices, in some examples. The present subject matter may be used in devices whether such devices are standard or custom fit and whether they provide an open or an occlusive design. It is understood that other hearing devices not expressly stated herein may be used in conjunction with the present subject matter.

### OTHER NOTES AND EXAMPLES

Example 1 is a system includes one or more display elements on or in a housing of a hearing device, and at least one processor configured to: detect a connection of a receiver cable to the hearing device, determine whether the receiver cable is compatible with a current programming of the hearing device, and based on whether the receiver cable is compatible with the current programming, use the one or more display elements to provide a notification to a user of the hearing device.

In Example 2, the subject matter of Example 1 optionally includes wherein the one or more display elements include light emitting diodes (LEDs).

In Example 3, the subject matter of any one or more of Examples 1-2 optionally includes wherein the one or more display elements include a graphical display.

In Example 4, the subject matter of any one or more of Examples 1-3 optionally includes wherein the notification includes providing a programmable color using the one or more display elements.

In Example 5, the subject matter of any one or more of Examples 1-4 optionally includes wherein the notification includes providing a programmable sequence using the one or more display elements.

In Example 6, the subject matter of any one or more of Examples 1-5 optionally includes wherein the notification includes providing a legible message using the one or more display elements.

In Example 7, the subject matter of any one or more of Examples 1-6 optionally includes wherein the notification includes an audible message delivered via a receiver of the hearing device.

In Example 8, the subject matter of any one or more of Examples 1-7 optionally includes wherein the notification includes a message sent to an electronic device in communication with the hearing device.

In Example 9, the subject matter of Example 8 optionally includes wherein the message is sent using a wireless network.

In Example 10, the subject matter of Example 8 optionally includes wherein the electronic device includes a programmer for the hearing device.

In Example 11, the subject matter of Example 8 optionally includes wherein the electronic device includes a smartphone.

In Example 12, the subject matter of Example 8 optionally includes wherein the electronic device includes a smartwatch.

In Example 13, the subject matter of any one or more of Examples 1-12 optionally includes wherein the notification includes an implied or express instruction for the user to reprogram the hearing device to be compatible with the receiver cable.

In Example 14, the subject matter of any one or more of Examples 1-13 optionally includes wherein the user is a wearer of the hearing device.

In Example 15, the subject matter of any one or more of Examples 1-14 optionally includes wherein the user is clinician or audiologist.

In Example 16, the subject matter of any one or more of Examples 1-15 optionally includes wherein the at least one processor is further configured to process an audio signal to correct for a hearing impairment of a wearer of the hearing device.

Example 17 is a system including one or more display elements on or in a housing of a hearing device, and at least one processor configured to: determine whether a receiver connected to the hearing device is streaming audio from the hearing device, determine whether the hearing device has activated ambient microphones of the hearing device, and based on whether the receiver of the hearing device is streaming audio or the hearing device has activated ambient microphones, use the one or more display elements to provide a notification to a user of the hearing device.

In Example 18, the subject matter of Example 17 optionally includes wherein the hearing device is a hearing aid.

In Example 19, the subject matter of Example 18 optionally includes wherein the hearing aid is a behind-the-ear (BTE) hearing aid.

In Example 20, the subject matter of Example 18 optionally includes wherein the hearing aid is a receiver-in-the-canal (RIC) hearing aid.

In Example 21, the subject matter of Example 18 optionally includes wherein the hearing aid is a receiver-in-the-ear (RITE) hearing aid.

Example 22 is a system including one or more display elements on or in a housing of a hearing device, and at least one processor configured to: determine a receiver size of a receiver connected to the hearing device, determine whether a receiver size of the receiver has sufficient headroom to provide an output audible by a wearer of the hearing device, and based on whether the receiver size of the receiver has sufficient headroom to provide the output audible, use the one or more display elements to provide a notification to a user of the hearing device.

In Example 23, the subject matter of Example 22 optionally includes wherein the one or more display elements include light emitting diodes (LEDs).

In Example 24, the subject matter of any one or more of Examples 22-23 optionally includes wherein the notification includes providing a programmable color using the one or more display elements.

In Example 25, the subject matter of any one or more of Examples 22-24 optionally includes wherein the notification includes providing a programmable sequence using the one or more display elements.

Example 26 is at least one machine-readable medium including instructions that, when executed by processing circuitry, cause the processing circuitry to perform operations to implement of any of Examples 1-25.

Example 27 is an apparatus comprising means to implement of any of Examples 1-25.

Example 28 is a system to implement of any of Examples 1-25.

Example 29 is a method to implement of any of Examples 1-25.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A system comprising:
one or more display elements on or in a housing of a hearing device; and
at least one processor configured to:
detect a connection of a receiver cable to the hearing device;
determine whether the receiver cable is compatible with a current programming of the hearing device; and
based on whether the receiver cable is compatible with the current programming, use the one or more display elements to provide a notification to a user of the hearing device.

2. The system of claim 1, wherein the one or more display elements include light emitting diodes (LEDs).

3. The system of claim 1, wherein the one or more display elements include a graphical display.

4. The system of claim 1, wherein the notification includes providing a programmable color using the one or more display elements.

5. The system of claim 1, wherein the notification includes providing a programmable sequence using the one or more display elements.

6. The system of claim 1, wherein the notification includes providing a legible message using the one or more display elements.

7. The system of claim 1, wherein the notification includes an audible message delivered via a receiver of the hearing device.

8. The system of claim 1, wherein the notification includes a message sent to an electronic device in communication with the hearing device.

9. The system of claim 8, wherein the message is sent using a wireless network.

10. The system of claim 8, wherein the electronic device includes a programmer for the hearing device.

11. The system of claim 8, wherein the electronic device includes a smartphone.

12. The system of claim 8, wherein the electronic device includes a smartwatch.

13. The system of claim 1, wherein the notification includes an implied or express instruction for the user to reprogram the hearing device to be compatible with the receiver cable.

14. The system of claim 1, wherein the user is a wearer of the hearing device.

15. The system of claim 1, wherein the user is clinician or audiologist.

16. The system of claim 1, wherein the at least one processor is further configured to:
process an audio signal to correct for a hearing impairment of a wearer of the hearing device.

17. A system comprising:
one or more display elements on or in a housing of a hearing device; and
at least one processor configured to:
determine whether a receiver connected to the hearing device is streaming audio from the hearing device;
determine whether the hearing device has activated ambient microphones of the hearing device; and
based on whether the receiver of the hearing device is streaming audio or the hearing device has activated ambient microphones, use the one or more display elements to provide a notification to a user of the hearing device.

18. The system of claim 17, wherein the hearing device is a hearing aid.

19. The system of claim 18, wherein the hearing aid is a behind-the-ear (BTE) hearing aid.

20. The system of claim 18, wherein the hearing aid is a receiver-in-the-canal (RIC) hearing aid.

21. The system of claim 18, wherein the hearing aid is a receiver-in-the-ear (RITE) hearing aid.

22. A system comprising:
one or more display elements on or in a housing of a hearing device; and
at least one processor configured to:
determine a receiver size of a receiver connected to the hearing device;
determine whether a receiver size of the receiver has sufficient headroom to provide an output audible by a wearer of the hearing device; and
based on whether the receiver size of the receiver has sufficient headroom to provide the output audible, use the one or more display elements to provide a notification to a user of the hearing device.

23. The system of claim 22, wherein the one or more display elements include light emitting diodes (LEDs).

24. The system of claim 22, wherein the notification includes providing a programmable color using the one or more display elements.

25. The system of claim 22, wherein the notification includes providing a programmable sequence using the one or more display elements.
